(19) United States
(12) Patent Application Publication
(10) Pub. No.: US 2025/0280839 A1
(43) Pub. Date: Sep. 11, 2025

(54) ANIMAL CARCASS APPARATUS AND METHOD FOR PROCESSING BEEF WITH THE APPARATUS

(71) Applicant: NSC Beef Processing, LLC, Baird, TX (US)

(72) Inventor: Gary Steven Hendrix, Abilene, TX (US)

(21) Appl. No.: 19/019,240

(22) Filed: Jan. 13, 2025

Related U.S. Application Data
(60) Provisional application No. 63/630,440, filed on Feb. 5, 2024.

(51) Int. Cl. A22B 5/06; A22B 5/00; A22B 7/00

(52) U.S. Cl. CPC A22B 5/06; A22B 5/0029; A22B 5/0035; A22B 5/0052; A22B 5/0076; A22B 7/004

(57) ABSTRACT

An animal carcass apparatus includes a support structure, a butchering platform and a carcass holding device. The butchering platform is moveably connected with the support structure and is constructed to support the mass of a person, and the carcass holding device includes a base and a securement mechanism. The carcass holding device is arranged in proximity with the butchering platform such that when a person is on the platform and a carcass is on the carcass holding device, the person contacts the carcass to butcher the carcass and moves the butchering platform to adjust the position of the person relative to the carcass holding device. Preferably, the butchering platform includes a linear actuator for vertical movement of the butchering platform. A method for processing beef includes processing beef with the animal carcass apparatus.

### BACKGROUND OF THE INVENTION

The present disclosure relates generally to an apparatus for holding an animal carcass and more specifically to an apparatus for supporting and arranging the carcass at different heights and angles allowing for butchering of a carcass.

When an animal carcass, such as a beef carcass, is prepared for butchering, typically the breastbone is cut, the internal organs are removed, and then the carcass is split and cooled.

Most methods of butchering involve hanging the carcass vertically by two limbs and cutting the breastbone to remove internal organs. The carcass is then split along the backbone, splitting the carcass in half, which makes it easier to handle. However, this causes meat contamination through spinal cord exposure.

There are multiple methods for supporting and arranging a beef carcass during the butchering process, such as with a beef spreading device. Such devices might include, hooks, rib spreaders, and hanging devices, to name a few. One such device is disclosed in the Hendrix U.S. Pat. No. 11,129,391 and includes a gear assembly, a pair of support arms, and a pair of plates connected with the support arms. The support arms have a first end connected with the gear assembly and a second end connected with spreading plates. When the gear assembly is operated, the plates are displaced between retracted and expanded positions to be inserted into and to engage the inner walls of a carcass ribcage, respectively. The frame is adjustable to provide linear displacement and rotation of the carcass holding device.

The benefit of such a device is that the backbone of the carcass need not be split, thus allowing for whole carcass butchering, which removes the potential for contamination that comes from cutting the spinal cord when splitting the carcass.

Though there are benefits to the device of the '391 patent, there is a need for further improvements such that a whole carcass can be butchered more efficiently and effectively without the need for splitting the carcass backbone and causing potential contamination of beef.

### SUMMARY OF THE INVENTION

Accordingly, it is an object of the present disclosure to provide an animal carcass apparatus that includes a support structure, a butchering platform and a carcass holding device. The butchering platform is moveably connected with the support structure and is constructed to support the mass of a person, and the carcass holding device includes a base and a securement mechanism. The carcass holding device is arranged in proximity with the butchering platform such that when a person is on the platform and a carcass is on the carcass holding device, the person contacts the carcass to butcher the carcass and moves the butchering platform to adjust the position of the person relative to the carcass holding device. Preferably, the butchering platform includes a linear actuator for vertical movement of the butchering platform.

In one embodiment, the butchering platform has a u-shaped configuration defining a central opening and the carcass holding device is arranged to extend through the central opening. The butchering platform preferably has a slotted top surface to allow for passage of material through the platform.

In a second embodiment, the support structure includes at least one post and preferably two parallel spaced posts.

In another embodiment, the carcass holding device further includes at least one vertically extendable post having a lower end connected with the base and an upper end connected with the securement mechanism. Further, the securement mechanism includes, a housing connected with the at least one vertically extendable post, a pair of support arms each extending out of a housing opening, and a pair of spreading plates each connected with one of the support arms.

In yet another embodiment, the securement mechanism is rotatably connected with the vertically extendable post.

In another embodiment, the securement mechanism is fixed in a vertical position, which allows gravity to assist in removing primal cuts and to hold hot beef. This secures the carcass to the machine with the holding device remaining attached to the rail.

In a further embodiment, the apparatus further includes a carcass conveyer arranged in proximity with the carcass holding device. The carcass conveyer includes at least one hanger configured to support an animal carcass such that when an animal carcass is connected with the hanger, the carcass conveyer is operated to move the carcass toward the carcass holding device. The conveyer is stopped when the carcass reaches the carcass holding device and the carcass is arranged on the carcass holding device.

It is further an object of the present disclosure to provide a method for processing beef that includes using the animal carcass apparatus with support structure described herein, including the steps of preparing a beef carcass for butchering, reducing the carcass temperature by 20 degrees Fahrenheit, removing primal cuts from the carcass, packaging and cooling the primal cuts to 32-34 degrees Fahrenheit, and preparing the packaged primal cuts for distribution. Alternatively, the carcass can be butchered without reducing the temperature after slaughter, which results in butchering in the range of 102-104 degrees Fahrenheit. To prepare the beef carcass, the head of the cattle is removed and the carcass is eviscerated. The carcass is then cooled for approximately three to four hours to lower its temperature to 75-85 degrees in preparation of removing the primal cuts. The carcass is then arranged on a butchering device such as the device disclosed in the Hendrix U.S. Patent Application Publication No. 2021/0227838, and the primal cuts are removed. The cuts are then placed in a cooler for approximately 60 minutes to reduce their temperature to 32-34 degrees Fahrenheit. The entire beef processing method, from kill floor to packaging, can be completed within 24 hours or less.

In one embodiment, preparing a beef carcass for butchering further includes scoring the carcass back without cutting through the carcass backbone or spinal cord, hanging the carcass by a carcass hind portion, removing the hind legs, inserting a hanging device through an opening in the carcass and extending the device through an opening in the carcass neck, inverting the carcass to hang from the hanging device, and removing the forelegs from the carcass.

In another embodiment, at least one of the cooling steps can be performed in an environment having a humidity of 84-92% to minimize beef shrinkage.

It is further an object of the present disclosure to provide a method for processing beef with the animal carcass apparatus with support structure described herein, including the step of preparing a beef carcass for butchering by hanging the carcass by a hind portion, removing the carcass head, eviscerating the carcass, removing the carcass hind legs, inverting the carcass, and removing the carcass fore legs without splitting the backbone or sternum. Next the carcass is arranged on a butchering device and removing primal cuts from the carcass, the primal cuts are packaged, and the cuts are cooled for three to six hours to a carcass internal temperature of 70-90 degrees Fahrenheit. Finally, the primal cuts are cooled for 50-70 minutes to an internal temperature of 32-38 degrees Fahrenheit for each primal cut, wherein processing of a beef carcass from initial slaughter to packaging primal cuts and then cooling the packaged primal cuts is complete within 24 hours or less.

### BRIEF DESCRIPTION OF THE DRAWINGS

Other objects and advantages of the disclosure will become apparent from a study of the following specification when viewed in the light of the accompanying drawing, in which:

FIG. 1 is a perspective view of an animal carcass apparatus according to the present disclosure;

FIG. 2 is a perspective view of the animal carcass apparatus of FIG. 1 with the platform in a raised position;

FIG. 3 is a perspective view of the animal carcass apparatus of FIG. 1 with the platform in a raised position and the spreading plates in their expanded position;

FIGS. 4 and 5 are front views of the carcass holding device of the animal carcass apparatus of FIG. 1 with an animal carcass arranged thereon;

FIG. 6 is a side view of the animal carcass apparatus of FIG. 1 with a carcass on the holding device according to the present disclosure;

FIG. 7 is a perspective view of the animal carcass apparatus of FIG. 1 with a carcass on the holding device;

FIG. 8 is a front perspective view of the animal carcass apparatus of FIG. 1 with the platform in a lowered position and a carcass on the holding device;

FIG. 9 is a top perspective view of the carcass holding device with a carcass being arranged thereon;

FIG. 10 is a flow chart showing steps for processing beef according to the present disclosure;

FIG. 11 is a front perspective view of a beef carcass hanging from its hind legs;

FIG. 12 is a top perspective view of a beef carcass hanging from its hind legs with a carcass hanging device inserted in a cavity of the carcass;

FIG. 13 is a front perspective views of a beef carcass hanging from a hind portion;

FIG. 14 is a front perspective view of a beef carcass in the process of being inverted according to the present disclosure;

FIG. 15 is a bottom perspective view of a beef carcass hanging from a carcass hanging device;

FIGS. 16 and 17 are rear and side perspective views, respectively, of a beef carcass hanging from a carcass hanging device;

FIG. 18 is a rear perspective view of a beef carcass that has been scored down its back; and

FIG. 19 is a perspective view of a beef carcass arranged on a butchering device.

### DETAILED DESCRIPTION

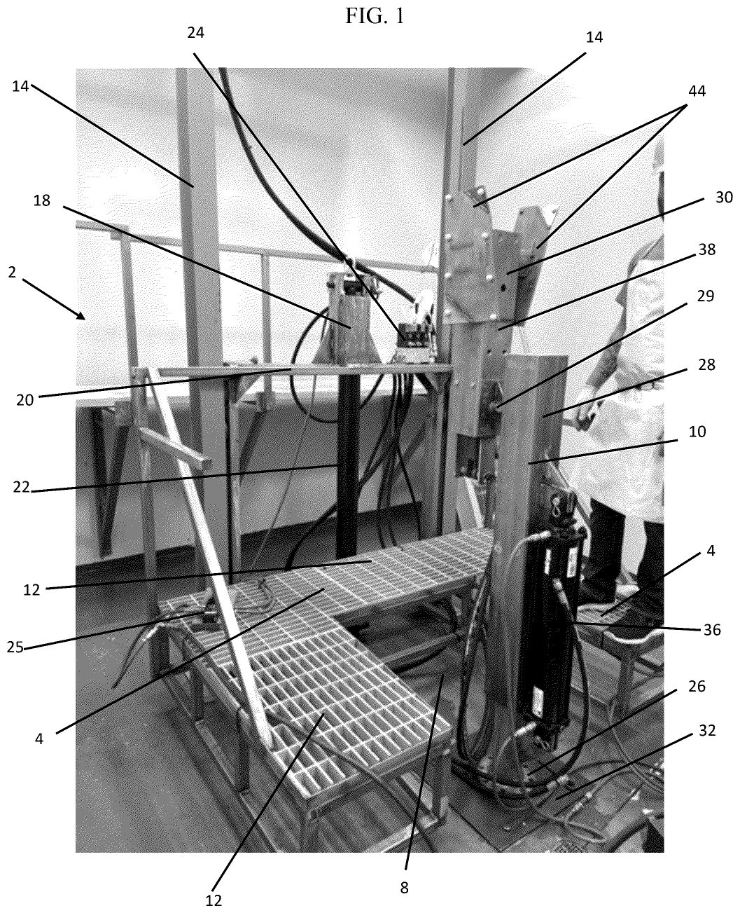

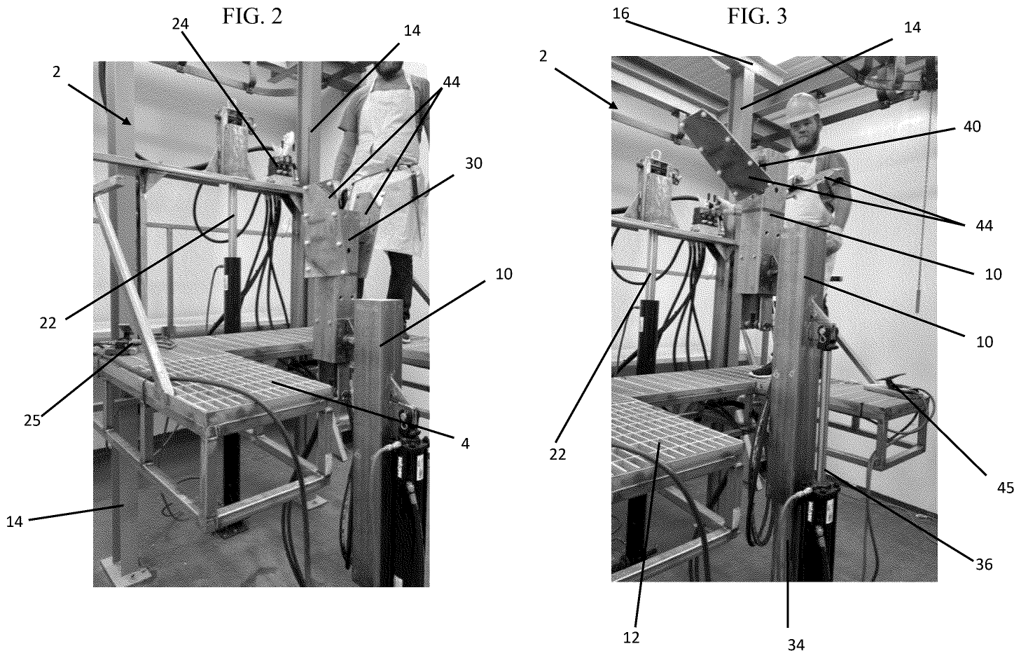

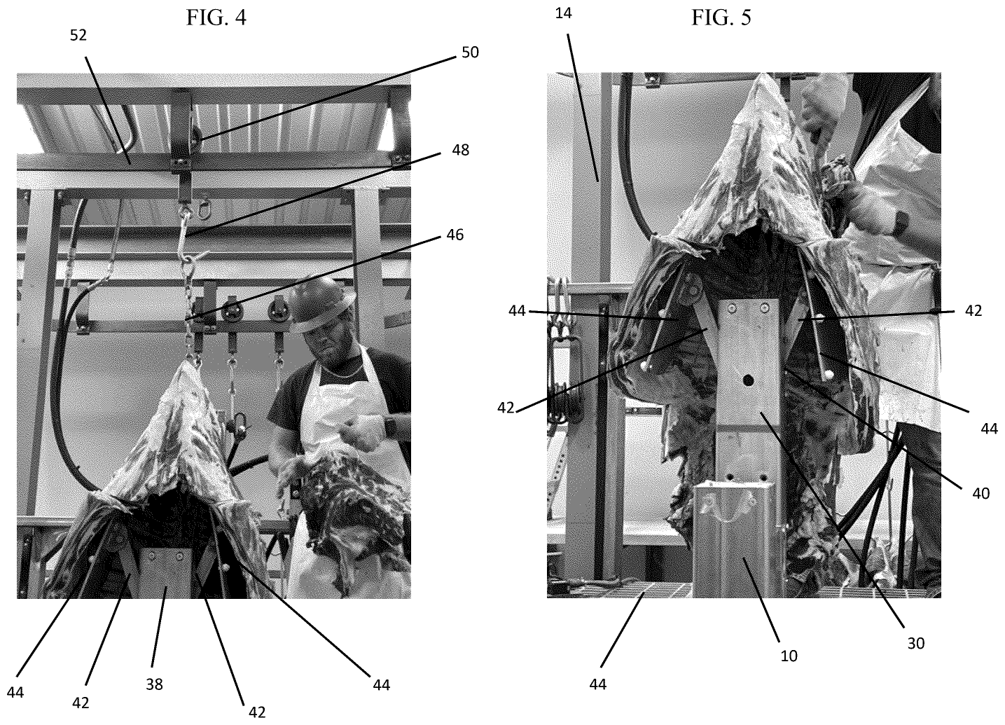

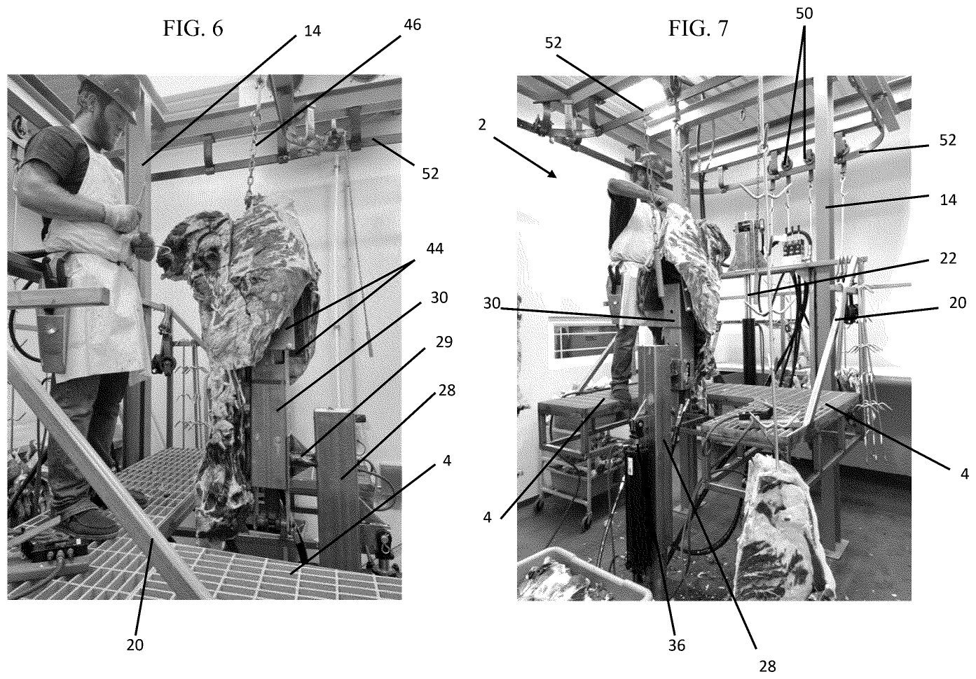

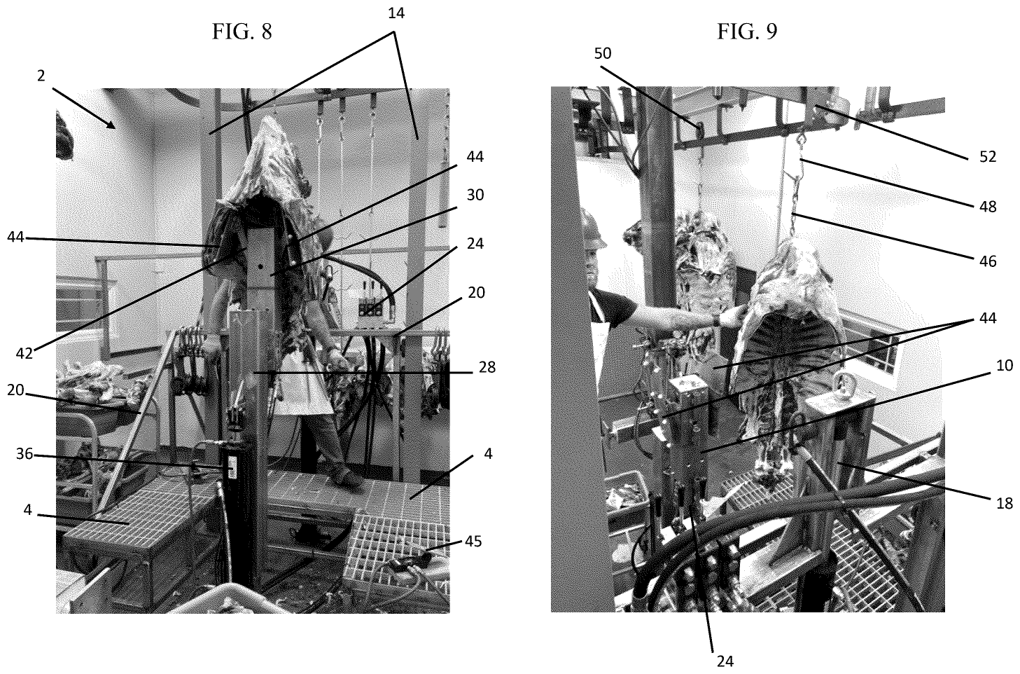

The present disclosure relates to an apparatus which allows for more efficient butchering of an animal, including allowing for butchering while the carcass is still hot and allowing for gravity to assist with removing cuts. Moreover, when using the device, the backbone of the carcass need not be split, allowing for whole carcass butchering, which removes the potential for contamination that comes from cutting the spinal cord when splitting the carcass. Referring first to FIGS. 1-3, the apparatus 2 includes a u-shaped platform 4 on which a butcher stands to prepare cuts of an animal carcass. In the central opening 8 that is defined by the u-shaped platform, there is a carcass holding device 10 which supports the animal carcass during butchering. As is shown in FIGS. 4-9, the animal carcass being butchered is that of beef cattle. It will be understood by those with skill in the art that the apparatus can also be used in the processing application of other animals, for instance with hogs, pigs, sheep, goats, deer, and any other animals.

Referring again to FIGS. 1-3, the platform 4 includes a slotted upper surface 12 to allow discarded animal remains to pass through, thus preventing a butcher from slipping or otherwise being obstructed by such remains. The platform is connected with a pair of parallel spaced posts 14 extending from the ground to an upper end support structure 16 (shown in FIG. 3). Between the posts, there is a hydraulic actuator 18 which is connected to a platform railing 20, and which is operated to raise and lower the platform 4. The hydraulic actuator is connected to the floor, between the posts, and includes a rod 22 connected with the railing to raise and lower the platform. A controller with switches 24 is operated to adjust the height of the platform relative to the carcass holding device 10. Alternative to the controller with switches, a foot pedal 25 is provided to control the height of the platform. It will be understood by those with skill in the art that the platform could vary in size from the embodiment shown in the figures. For instance, the shape of the platform may be something other than U-shaped and the width of each portion may be greater or less. Moreover, controllers used by hand or feet arranged in varying proximity to the platform and carcass holding device are contemplated.

The support structures used with the apparatus are I-beams. It will be understood by those with skill in the art that other support structures could be used, such as square tubing with dual cylinders.

As is shown throughout the figures, the platform 4 and carcass holding device 10 are arranged such that a butcher can easily contact a carcass 6 on the holding device and implement cuts from multiple positions and at different angles above and below the carcass.

The carcass holding device 10 includes a base 26 connected with the floor, an adjustable post 28 connected with the base and a securement mechanism 30 connected with the adjustable post. The base includes a plate 32 that is bolted to the floor and a projection 34 extending vertically therefrom and connected therewith. In an alternative embodiment, the securement mechanism and adjustable post are a single unit. Moreover, the securement mechanism, adjustable post, or both could be connected with, and move via, a cylinder.

The adjustable post 28 can be raised or lowered relative to the base projection 34 via a hydraulic actuator 36. A shown in FIGS. 7-9, when arranging a carcass 6 on the carcass holding device 10, the adjustable post 28 is lowered via the hydraulic actuator 36, a carcass is arranged above the holding device, the adjustable post is raised to insert the securement mechanism 30 into the cavity of the carcass, and the carcass is secured for butchering. It will be understood by those with skill in the art that the actuator may be powered by a liquid, such as water or oil, gas, or other methods.

The securement mechanism 30 includes a housing 38 having two opposite openings 40 through which a pair of support arms 42 extend. A pair of plates 44 are connected with the support arms and are configured to be inserted into the cavity of an animal carcass. Once inserted, the support arms are operated via a linear cylinder (not shown here), which extends the support arms, thereby extending the plates in an outward direction against the inner walls of the carcass cavity, securing the carcass on the securement mechanism. Alternate to the linear cylinder, a motor with gear worm could be used to operate the support arms. The carcass holding device is operated via a controller 45, which includes a foot pedal, though hand controllers are also contemplated.

The securement mechanism 30 is connected with the adjustable post 28 and cylindrical connector 29. This could be fixed or rotatable, though a fixed position is preferable for a hot carcass. Rotation of the securement mechanism can make it challenging to keep a hot carcass thereon. However, a rotatable connector 29 allows for angular movement of the securement mechanism relative to the adjustable post to vary the angle of a carcass on the machine. The connector 29 could be fixed or rotatable without deviating from the spirit and scope of the invention.

The carcass holding device disclosed herein is similar to the carcass holding device disclosed in U.S. Pat. No. 11,129,391. The entire content of the '391 patent is incorporated herein by reference. Different from the '391 patent, the carcass holding device can be configured to rotated but this is not required to obtain the benefits of the entire apparatus disclosed herein.

One advantage of the apparatus disclosed herein is that an animal carcass can be butchered while hot, reducing a significant amount of time from the entire butchering process. Rather than first cooling the carcass, the beef carcass is butchered on the apparatus and cooled after all the beef cuts have been completed. This results in a significantly reduced butcher to truck time. Moreover, the apparatus with spreading plates allows a beef carcass to be butchered without splitting the breastbone and backbone. This reduces time and effort needed to butcher a beef carcass, and also removes the risk of spinal cord contamination. A further advantage is that butchering the carcass while it is still hot or warm reduces injuries such as carpal tunnel syndrome to those butchering the beef carcass.

Referring now to FIGS. 4 and 6-9, the apparatus further includes a conveyer system. The carcass is hung by a hanger inserted into the cavity of the carcass (not shown), which includes a chain 46, that is connected with a hook 48 further connected with a wheel 50 arranged on a conveyer 52. As is shown in FIG. 9, more than one carcass can be hung from more than one hook. Each carcass is moved to the carcass holding device 10 via the wheel and conveyer, is secured on the device as described herein, and then is butchered. Once all cuts are performed, the carcass holding device is removed from the cavity of the carcass and the next carcass is moved via the wheel and conveyer to the carcass holding device. The adjustable platform, adjustable carcass holding device and conveyer provide for a butchering apparatus that is more effective and more efficient than those known in the prior art.

The above machine and elements make it possible to butcher a carcass with temperatures that range from 32 to 104 degrees Fahrenheit. This significantly improves methods for butchering.

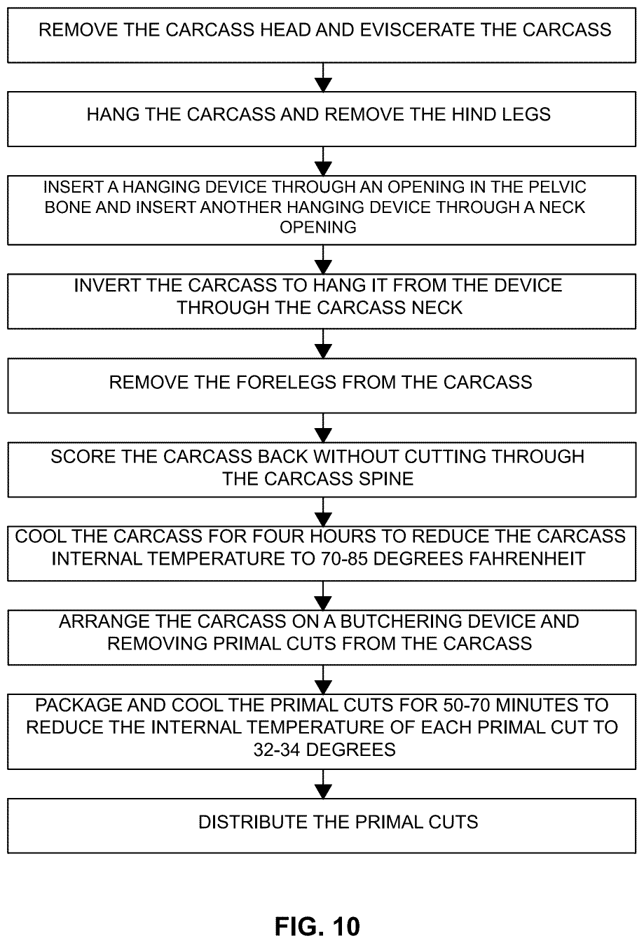

Referring to FIG. 10, the method includes first removing the cattle head and then eviscerating the carcass so that all internal organs and potential contaminates are separated from the meat that will be processed. Unlike with other butchering methods, the sternum is not split prior to evisceration. The head and organs are then inspected to ensure the cattle carcass is acceptable for human consumption. If it is acceptable, the butchering process continues. At this time, it is expected that the internal temperature of the carcass will be 102-104 degrees Fahrenheit, though that range may vary.

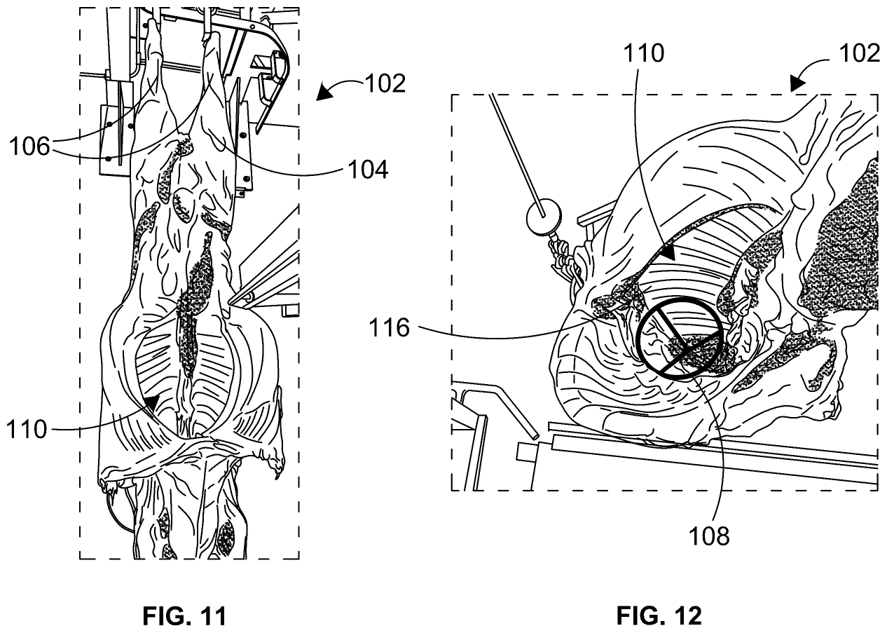

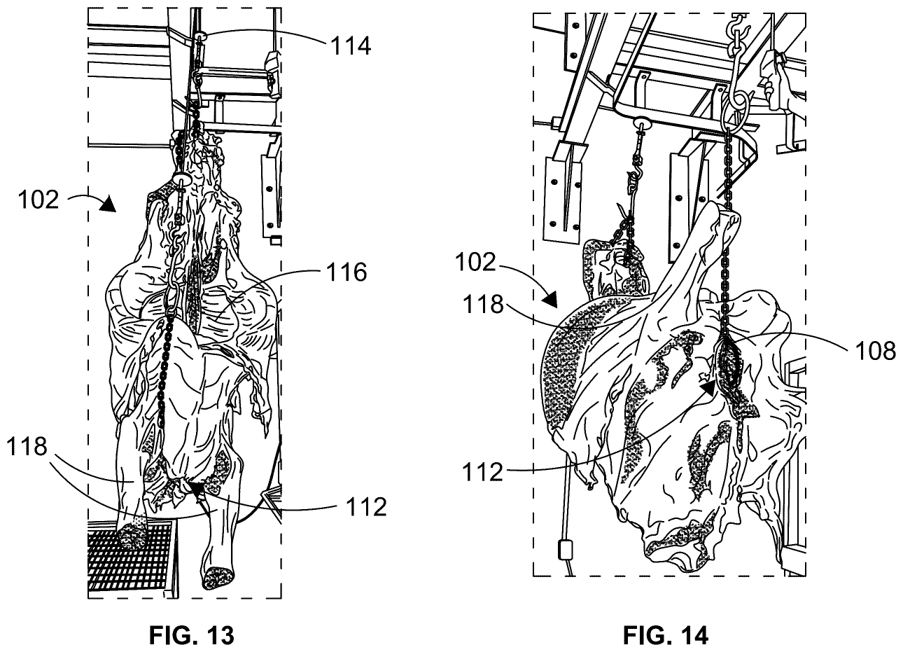

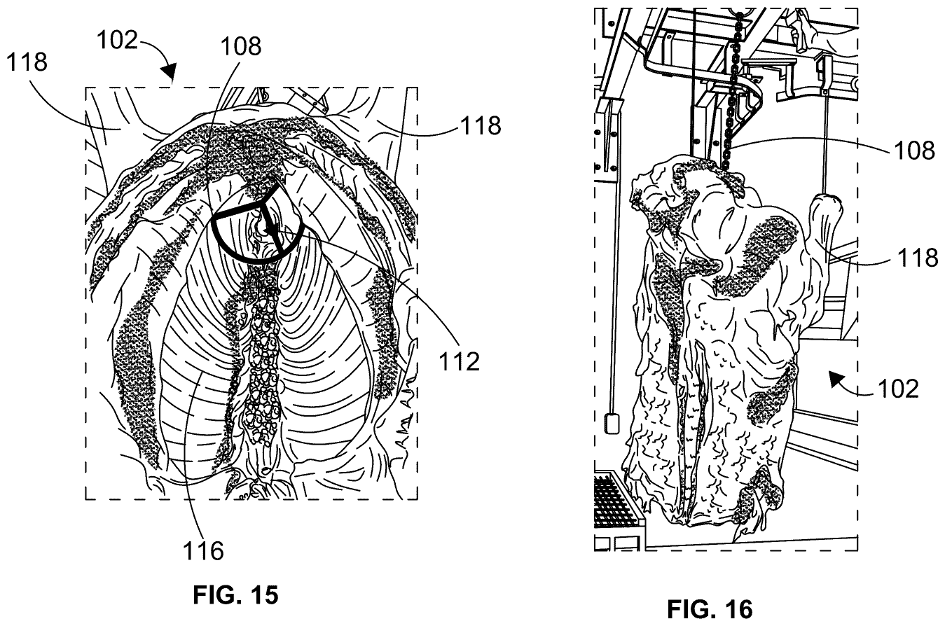

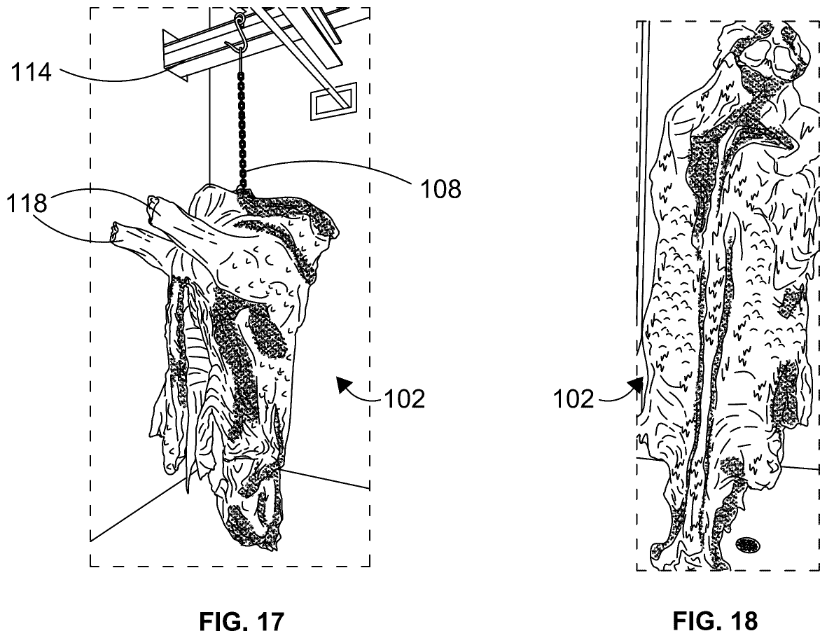

Referring now to FIG. 11, to butcher the carcass according to the present method, the carcass 102 is first hung by its hind portion 104 and then the hind legs 106 are removed. FIGS. 16 and 17 show the carcass being supported by a hanging device 108. FIGS. 12 and 13 show the device as it is inserted through a carcass opening 110, extended through a carcass neck opening 112, and hung from a support structure 114, such as a beam. The carcass is then inverted, as shown in FIG. 14, so that it hangs from and is supported by the device 108. FIG. 15 shows the device fully inserted into the carcass and contacting an inner surface 116 of the carcass.

Referring again to FIGS. 16 and 17, once the carcass 102 is inverted, it is supported by the hanging device 108 connected with a support structure 114. At this time, the forelegs 18 are removed from the carcass and the carcass is scored down its backbone, which is shown in FIG. 18.

As further detailed in FIG. 10, the carcass is then cooled for approximately three to four hours to an internal temperature in the range of 75 to 85 degrees Fahrenheit, though temperatures as low as 32 degrees and as high as 104 degrees are acceptable and butchering can be accomplished at such temperatures with the machine described herein. A standard cooler known in the beef processing industry can be used to reduce the temperature, though as discussed below, the size and environment of the cooler may vary. Once the carcass reaches the desired internal temperature, it is removed from the cooler. The carcass is then ready for removal of all primal cuts. Importantly, unlike with known methods for butchering cattle, the backbone is never cut and the carcass is not split into two halves, thus removing the potential for contamination that arises when cutting through the spinal cord.

Preferably, the cooling process takes place in an environment having a relative humidity of 84-92%. This, in addition to the shortened three to four hour cooling period, results in beef shrinkage of less than 1% and in some instances as low as half of a percent. This is an important improvement over the industry standard of 2% shrinkage, resulting in more high quality beef.

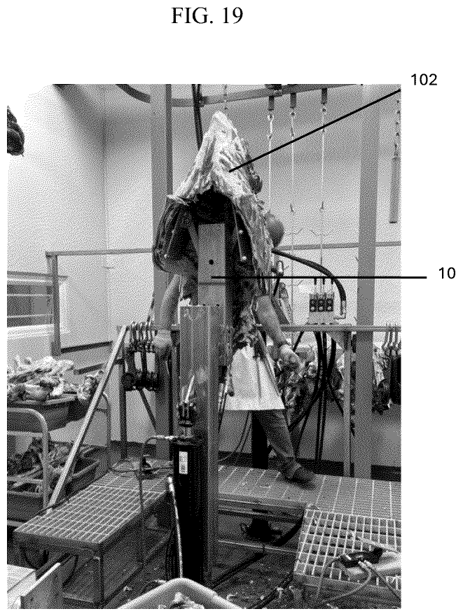

Referring now to FIG. 19, the carcass 102 is arranged on a butchering device 10 such as the device described herein, which is used to maneuver the carcass while removing the primal cuts. The apparatus allows for varying the height and position of the carcass, making the butchering process easier on butchers as compared to other known methods and devices. Moreover, the device does not require the back or sternum to be split, again reducing the potential for contamination as a result of such practices.

Once the carcass is arranged on the device, the primal cuts are removed, which can be completed in 15-30 minutes due to the ease of butchering with the device. The primal cuts are then packaged and cooled for approximately 60 minutes until an internal temperature of each primal cut reaches approximately 32 to 38 degrees Fahrenheit. From there, the packaged cuts are prepared for shipping or boxed and held in a storage cooler and shipped at a later date. This entire process from eviscerating the cattle to removing, packaging and cooling the primal cuts is completed in approximately 24 hours or less, well below the industry standard of 3 to 4 days.

As noted above, removing primal cuts when the carcass reaches a temperature of 75-85 degrees Fahrenheit, as opposed to the industry standard of 44 degrees, significantly reduces the time from kill floor to butchering and packaging. Though temperatures in the range of 32 to 104 degrees Fahrenheit would be acceptable for butchering. This in turn reduces the potential for pathogens or otherwise harmful bacteria to grow. Butchering beef at a higher temperature is also better for butchers. Removing primal cuts is a difficult task that places a lot of stress on butchers. By butchering at a higher temperature than is standard in the industry, less effort is required for each cut and thus conditions associated with butchering cattle, such as carpel tunnel syndrome, are reduced.

Producing beef with this method is also beneficial to the quality of the meat. As noted above, there is less of a chance of contamination, but also the beef will be of a better quality over beef produced through other methods that often require at least 24 hours of cooling prior to butchering and have a total production time of 3 to 4 days. Because of the decreased cooling time of this method, the resulting meat will be more tender, it will better retain its natural juices and enzymes, and have a shelf life that is approximately two days longer than other methods. Also, as noted above, the rate of shrinkage will be decreased significantly.

A further benefit of the present method is the reduction of energy needed to produce beef, which in turn will reduce costs and lessen the environmental impact of processing plants that use this method. The reduction of energy results from the shorter time required to cool a carcass prior to removing primal cuts and the overall reduction in time from kill floor to packaging. Moreover, by removing primal cuts prior to lowering beef temperatures to 32-34 degrees Fahrenheit, the size of a cooler for the final stage of cooling prior to packaging can be reduced. For known methods wherein full cattle carcasses are hung in coolers for at least 24 hours until they reach 44 degrees Fahrenheit, a greater number of large coolers, often having a height of approximately 14 feet, are needed to house the many cooling carcasses. For the present method, due to the shorter initial cooling period, a lesser number of large coolers are needed, and for coolers used to reduce the temperature of primal cuts, the size of the cooler can be reduced to approximately 9 feet. Reducing the total number of large coolers and reducing the size of coolers for primal cuts reduces energy usage which in turn provides cost savings and lessens the environmental impact of processing plants.

Although the above description references particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

What is claimed is:

1. An animal carcass apparatus, comprising:
a. a support structure;
b. a butchering platform moveably connected with the support structure, the butchering platform constructed to support the mass of a person; and
c. a carcass holding device arranged in proximity with the butchering platform, the carcass holding device including a base and a securement mechanism, the butchering platform being moveable relative to the carcass holding device, whereby when a person is on the platform and a carcass is on the carcass holding device, the person contacts the carcass to butcher the carcass and moves the butchering platform to adjust the position of the person relative to the carcass holding device, removing primal cuts while keeping the backbone intact without cutting the spinal cord or splitting the carcass.

2. The animal carcass apparatus according to claim 1, wherein the butchering platform includes a linear actuator for vertical movement of the butchering platform.

3. The animal carcass apparatus according to claim 1, wherein the butchering platform has a u-shaped configuration defining a central opening, the carcass holding device being arranged to extend through the central opening.

4. The animal carcass apparatus according to claim 3, wherein the butchering platform has a slotted top surface.

5. The animal carcass apparatus according to claim 4, wherein the support structure includes at least one post.

6. The animal carcass apparatus according to claim 5, wherein the support structure includes two parallel spaced posts.

7. The animal carcass apparatus according to claim 1, wherein the carcass holding device further includes at least one vertically extendable post having a lower end connected with the base and an upper end connected with the securement mechanism.

8. The animal carcass apparatus according to claim 7, wherein the securement mechanism includes a housing connected with the at least one vertically extendable post, a pair of support arms each extending out of a housing opening, and a pair of spreading plates each connected with one of the support arms.

9. The animal carcass apparatus according to claim 8, wherein the securement mechanism is one of rotatably connected with the at least one vertically extendable post and fixed from rotation.

10. The animal carcass apparatus according to claim 1, and further comprising a carcass conveyer arranged in proximity with the carcass holding device, the carcass conveyer including at least one hanger configure to support an animal carcass, whereby when an animal carcass is connected with the hanger, the carcass conveyer is operated to move the carcass toward the carcass holding device, the conveyer is stopped when the carcass reaches the carcass holding device, and the carcass is arranged on the carcass holding device.

11. The animal carcass apparatus according to claim 10, wherein the carcass conveyer is configured to be hand driven.

12. A method for processing beef with the animal carcass apparatus defined in claim 1, comprising the steps of:
a. preparing a beef carcass for butchering including removing the carcass head and eviscerating the carcass;
b. cooling the carcass for three to four hours;
c. arranging the carcass on the carcass holding device securement mechanism and removing primal cuts from the carcass;
d. packaging the primal cuts; and
e. cooling the primal cuts for 50-70 minutes to an internal temperature of 32-38 degrees Fahrenheit for each primal cut wherein processing of a beef carcass from initial slaughter to packaging primal cuts is complete within 24 hours.

13. A method for processing beef as defined in claim 12, wherein the first cooling step includes cooling the carcass for three to four hours to a carcass internal temperature of 70-85 degrees Fahrenheit.

14. A method for processing beef as defined in claim 12, wherein the second cooling step includes cooling the primal cuts for 50-70 minutes to an internal temperature of 32-38 degrees Fahrenheit for each primal cut.

15. A method for processing beef as defined in claim 12, wherein preparing a beef carcass for butchering further includes scoring the carcass back without cutting through the carcass spine.

16. A method for processing beef as defined in claim 13, wherein preparing a beef carcass for butchering step further includes:
i. hanging the carcass by a carcass hind portion and removing the hind legs;
ii. inserting a hanging device through an opening in the carcass neck;
iii. inverting the carcass to hang from the hanging device through the carcass neck; and
iv. removing the forelegs from the carcass.

17. A method for processing beef as defined in claim 16, wherein hanging the carcass by a carcass hind portion includes hanging the carcass by an opening in the carcass pelvic bone.

18. A method for processing beef as defined in claim 17, wherein inserting a hanging device step includes inserting an inverted hanging device through an opening in the carcass neck.

19. A method for processing beef as defined in claim 12, wherein at least one cooling step is performed in an environment having a humidity of 84-92 percent.

20. A method for processing beef with the animal carcass apparatus defined in claim 1, comprising the steps of:
a. preparing a beef carcass for butchering including hanging the carcass by a hind portion, removing the carcass head, eviscerating the carcass, removing the carcass hind legs, inverting the carcass, and removing the carcass fore legs without splitting the backbone or sternum;
b. arranging the carcass on a butchering device and removing primal cuts from the carcass;
c. packaging the primal cuts;
d. cooling the carcass for three to six hours to a carcass internal temperature of 70-90 degrees Fahrenheit; and
e. cooling the primal cuts for 50-70 minutes to an internal temperature of 32-38 degrees Fahrenheit for each primal cut, wherein processing of a beef carcass from initial slaughter to packaging primal cuts and then cooling the packaged primal cuts is complete within 24 hours.
